(19) United States
(12) Patent Application Publication
(10) Pub. No.: US 2019/0043121 A1
(43) Pub. Date: Feb. 7, 2019

(54) ENHANCED RIDE SHARING FARE DETERMINATION

(71) Applicant: INTERNATIONAL BUSINESS MACHINES CORPORATION, ARMONK, NY (US)

(72) Inventors: WEST BARNES, RALEIGH, NC (US); HEIDI LAGARES-GREENBLATT, JEFFERSON HILLS, PA (US); JENNY S. LI, CARY, NC (US); XINLIN WANG, IRVINE, CA (US)

(21) Appl. No.: 15/668,153

(22) Filed: Aug. 3, 2017

(51) Int. Cl. G06Q 30/08; G06Q 50/30; G06Q 20/12; G06Q 10/02

(52) U.S. Cl. CPC G06Q 30/08; G06Q 10/025; G06Q 20/127; G06Q 50/30

(57) ABSTRACT

Embodiments include methods, systems and computer program products for determining a fare split for a ride share. Aspects include receiving a request for the ride share, the request including a pickup location, a drop off location and a proposed fare contribution. Aspects include identifying candidates for the ride share from a plurality of riders based on a user profile of the user. Aspects also include transmitting the request for the ride share to the candidates, the request indicating an estimated impact on a current trip of the candidates. Aspects also include receiving one or more positive responses to the request, the responses indicating a desired fare contributions for the ride share and determining a match from the one or more positive responses. Aspects include transmitting a match notification to the user and a selected match and transmitting an updated itinerary to a driver of the ride share.

### BACKGROUND

The present disclosure relates to the field of ride sharing, and more specifically, to determining how to split fares between riders using a ride sharing system.

The recent increase in utilization of services such as UBER® and LYFT® has increased the availability and demand for ride sharing. Current ride sharing services allow individuals, either strangers or acquaintances, to split the cost of a fare for a ride. However, the determination of how much each rider should to pay for their portion of the ride can be difficult and subjective problem. When determining how to split a fare amongst multiple riders, there are many variables to consider, such as the length of each rider's trip, the percentage of the trip that each rider will be sharing the ride and the amount of time the ride share adds to each rider's trip.

Currently available ride sharing services utilize very basic algorithms for splitting fares amongst multiple riders. For example, UBER® currently splits the cost evenly between multiple riders, even though the individuals may have trips of disparate lengths.

### SUMMARY

In accordance with one embodiment, a computer-implemented method for determining a fare split for a ride share is provided. The method includes receiving, from a user, a request for the ride share, the request comprising request data that includes a pickup location, a drop off location and a proposed fare contribution and identifying, by a processor of a ride sharing system, one or more candidates for the ride share from a plurality of riders based on a user profile of the user, the request data and a user profile of one or more of the plurality of riders. The method also includes transmitting, by the ride sharing system, the request for the ride share to the one or more candidates, the request indicating an estimated impact on a current trip of the one or more candidates. The method further includes receiving, by the ride sharing system, one or more positive responses to the request, the responses indicating a desired fare contributions for the ride share and determining, by the processor, a match from the one or more positive responses. The method also includes transmitting, by the ride sharing system, a match notification to the user and a selected match and transmitting an updated itinerary to a driver of the ride share.

In accordance with another embodiment, a system for determining a fare split for a ride share is provided. The system includes at least one processor and a memory, operably coupled to the at least one processor, the memory storing processor computer readable instructions. The at least one processor is configured to execute computer readable instructions, which cause the processor to receive, from a user, a request for the ride share, the request comprising request data that includes a pickup location, a drop off location and a proposed fare contribution. The computer readable instructions also cause the processor to identify one or more candidates for the ride share from a plurality of riders based on a user profile of the user, the request data and a user profile of one or more of the plurality of riders. The computer readable instructions further cause the processor to transmit the request for the ride share to the one or more candidates, the request indicating an estimated impact on a current trip of the one or more candidates. The computer readable instructions also cause the processor to receive one or more positive responses to the request, the responses indicating a desired fare contributions for the ride share. The computer readable instructions further cause the processor to determine a match from the one or more positive responses and transmit a match notification to the user and a selected match and transmitting an updated itinerary to a driver of the ride share.

In accordance with another embodiment, a computer program product, the computer program product comprising a computer readable storage medium having program instructions embodied therewith, the program instructions executable by a processor to cause the processor to receive, from a user, a request for the ride share, the request comprising request data that includes a pickup location, a drop off location and a proposed fare contribution. The program instructions also cause the processor to identify one or more candidates for the ride share from a plurality of riders based on a user profile of the user, the request data and a user profile of one or more of the plurality of riders. The program instructions further cause the processor to transmit the request for the ride share to the one or more candidates, the request indicating an estimated impact on a current trip of the one or more candidates. The program instructions also cause the processor to receive one or more positive responses to the request, the responses indicating a desired fare contribution for the ride share. The program instructions further cause the processor to determine a match from the one or more positive responses and transmit a match notification to the user and a selected match and transmitting an updated itinerary to a driver of the ride share.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings, in which:

FIG. 1 illustrates an example of a computer system in accordance with one or more embodiments of the present invention;

FIG. 2 illustrates an exemplary system in accordance with one or more embodiments of the present invention;

FIG. 3 illustrates an example of a method in accordance with one or more embodiments of the present invention;

FIG. 4 illustrates another exemplary method in accordance with one or more embodiments of the present invention; and

FIG. 5 illustrates yet another exemplary method in accordance with one or more embodiments of the present invention.

### DETAILED DESCRIPTION

Embodiments of the present disclosure include systems, computer program products, and methods for determining a fare split for a ride share. In exemplary embodiments, users of a ride sharing service are able to determine how to split the fare for a ride share in a manner that is agreeable to each rider. In one embodiment, a user desiring to share a ride can submit a proposed fare amount along with their request for a ride share. This ride share request can be transmitted to riders that are identified as candidates for sharing the ride and the candidate riders can be asked for a requested fare amount to share their ride or the riders can be presented with the proposed fare amount. Responses from the candidate riders are received and analyzed and a match for the requested ride share is identified. In exemplary embodiments, the identification of candidates and the determination of a match for the ride share can be based at least in part on the user preferences of the riders. Once a ride share match has been identified, the riders and the driver are each notified on the match and an updated itinerary is transmitted to the drive.

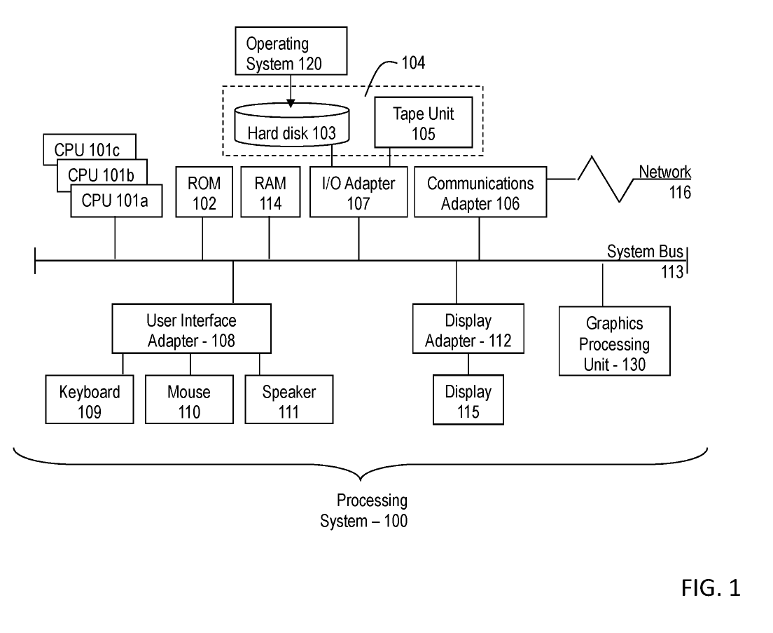

FIG. 1 illustrates an example of a computer system in accordance with one or more embodiments of the present invention. As shown, a processing system 100 one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are operably coupled to various components of system 100 via system bus 113. Read only memory (ROM) 102 is coupled to the system bus 113 and may include a basic input/output system (BIOS), which controls certain basic functions of system 100.

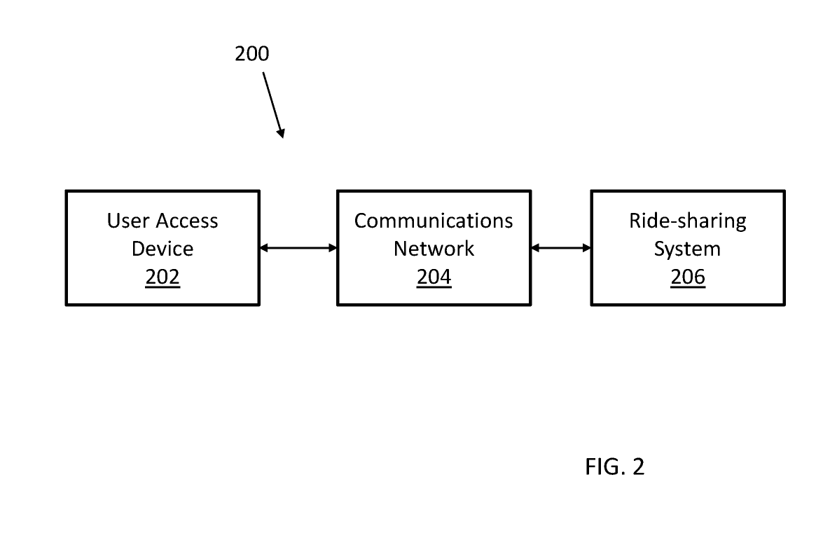

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with network 116 enabling system 100 to communicate with other (internal or external) systems (not depicted). In some embodiments, network 116 can be a communications network 204 (FIG. 2).

Referring again to FIG. 1, a screen (e.g., a display monitor) 115 is connected to system bus 113 by display adaptor 112, which may include a graphics adapter to improve the performance of graphics intensive applications and a video controller. In one or more embodiments, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters, which may include protocols, such as the Peripheral Component Interconnect (PCI) protocol. Additional exemplary input/output devices are shown as connected to system bus 113 via user interface adapter 108 and display adapter 112. In one or more embodiments, keyboard 109, mouse 110, and speaker 111 are all interconnected to bus 113 via user interface adapter 108, which may be embodied (by way of example only) as multiple device adapters (not depicted) or may combine one or more device adapters into a single integrated circuit (sometimes referred to as a super I/O chip).

Thus, as illustrated in FIG. 1, processing system 100 includes: processing capability in the form of processors 101; memory in the form of ROM 102, RAM 114 (sometimes referred to as system memory) and mass storage 104; input means in the form of keyboard 109 and mouse 110; and output capability in the form of speaker 111 and display 115. In one or more embodiments, a portion of system memory 114 and mass storage 104 collectively store an operating system, whose functions can include coordination of various system components. The memory can also store one or more applications, that when executed by the processor 101, perform one or more methods of the present invention.

Referring to FIG. 2, a system 200 in accordance with one or more embodiments of the present invention. In some embodiments, the system 200 can be implemented as a client-server architecture. As depicted, the system 200 includes a user access device 202 in communication with a ride sharing system 206, which hosts a ride sharing service, via a communications network 204. In some embodiments, user access device 202 can be a mobile device, such as a mobile phone that is operably coupled to ride sharing system 206 via communications network 204. In some embodiments, ride sharing system 206, can embody aspects of system 100 depicted in FIG. 1, in which the user device 202 accesses the ride sharing system 206 via hard-wired e.g., “Ethernet” and/or wireless e.g., “cellular” or “Wi-Fi” aspects of network 116. In some embodiments, ride sharing system 206, can be partly (or entirely) embodied in a so-called “cloud” environment associated with network 204. In some embodiments, communications network 204 can include an internal local area network (LAN) and/or a public communications network such as the Internet, or a combination of various networks.

In exemplary embodiments, the ride sharing system 206 can store data that includes a profile of each user of the ride sharing system 206 and the ride sharing preferences of each user of the ride sharing system 206. The profile of each user can include, but is not limited to, a gender, an age or an ethnicity of each user. The user profile can further include stored methods of payment for the user, common pickup and drop off locations for the user, and a user rating that is generated based on feedback from drivers and other riders in the ride sharing system 206. The ride sharing preferences of each user can include, but are not limited to, a minimum rating of a rider that a user is willing to share a ride with, a maximum amount of time a user is willing to wait to obtain a ride share, a preferred gender of a rider that a user is willing to share a ride with, a maximum disruption to a ride that the user is willing to endure to share a ride, and the like.

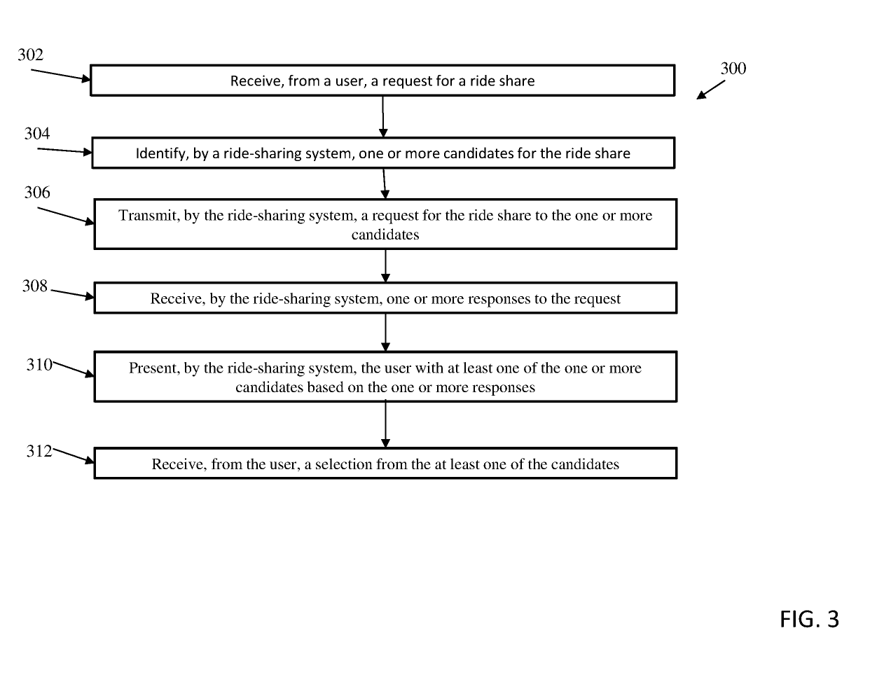

Referring to FIG. 3, a flowchart of a method 300 for determining a fare split for a ride share in accordance with one or more embodiments of the present invention. As illustrated, at block 302, the method 300 includes receiving a request for a ride share from a user of a ride sharing system. The request includes a pickup location, a dropoff location and may include a proposed fare contribution from the user for the ride share. Next, as shown at block 304, the method 300 includes identifying, by a ride sharing system, one or more candidates for the requested ride share. In exemplary embodiments, identifying the one or more candidates can include identifying riders that are on, or that are scheduled to take, a trip that at least partially overlaps with the requested ride share. In addition, identifying the one or more candidates can include analyzing the user profile and ride sharing preferences of both the requestor and of the previously identified riders.

Once one or more candidates for the requested ride share have been identified, the method 300 includes transmitting, by the ride sharing system, a request for the ride share to the one or more candidates, as shown at block 306. In exemplary embodiments, the transmitted request may include the proposed fare contribution provided by the user or it may indicate an amount that the rider's fare will be reduced by, which may or may not be equal to the proposed fare provided by the user. In one case the user may be willing to contribute ten dollars for the ride share but the added cost to the driver will be two dollars. In this case, the request can be transmitted to the current rider with an indication that their fare will be reduced by eight dollars if they accept the ride share request. In addition, the transmitted request can include an estimated impact that the ride share will have on the rider's trip, i.e., how much time it will likely add to their trip.

Next, as shown at block 308, the method 300 includes receiving, by the ride sharing system, one or more responses to the request. The responses indicate whether the one or more candidates are willing to participate in the requested ride share and the request may indicate a desired fare reduction that the rider would require to participate in the requested ride share. Next, as shown at block 310, the method 300 includes presenting, by the ride sharing system, the user with at least one of the one or more candidates based on the one or more responses. The method 300 also includes receiving, from the user, a selection from the at least one of the candidates, as shown at block 312.

In one example, a first user is on a trip and they have agreed to pay a twenty dollar fare. A second user wants to participate in a ride share that has a large amount of overlap with the trip of the first user. The second user has provided a twelve dollar desired fare and the user profile and preferences of the users do not prevent them from sharing a ride. In various embodiments, the ride sharing system can utilize various methods for determining the fare split amongst the two users. In one example, the ride sharing system can propose the ride share to the first user reflecting a twelve dollar decrease in their fare, i.e., giving the first user the entire amount that the second user is willing to pay. In another example, the ride sharing system can propose the ride share to the first user reflecting a ten dollar decrease in the first rider's fare and an increase to the driver of two dollars. In a further example, the ride sharing system can propose the ride share to the first user and ask the first user to provide an amount that the first user would want to require to accept the ride share. In the last scenario, the first user and the second user could even split the difference between the amounts that each is willing to pay, assuming that there is a positive overlap, or they could elect to split a portion of the overlap with the driver. In exemplary embodiments, the type of offers from the above types that a user would prefers could be stored as part of a user's ride sharing preferences file that is used to identify compatible ride share participants. These preferences could be explicitly set by the user or the ride sharing system could learn these preferences over time based on the types of ride shares that the user accepts and rejects.

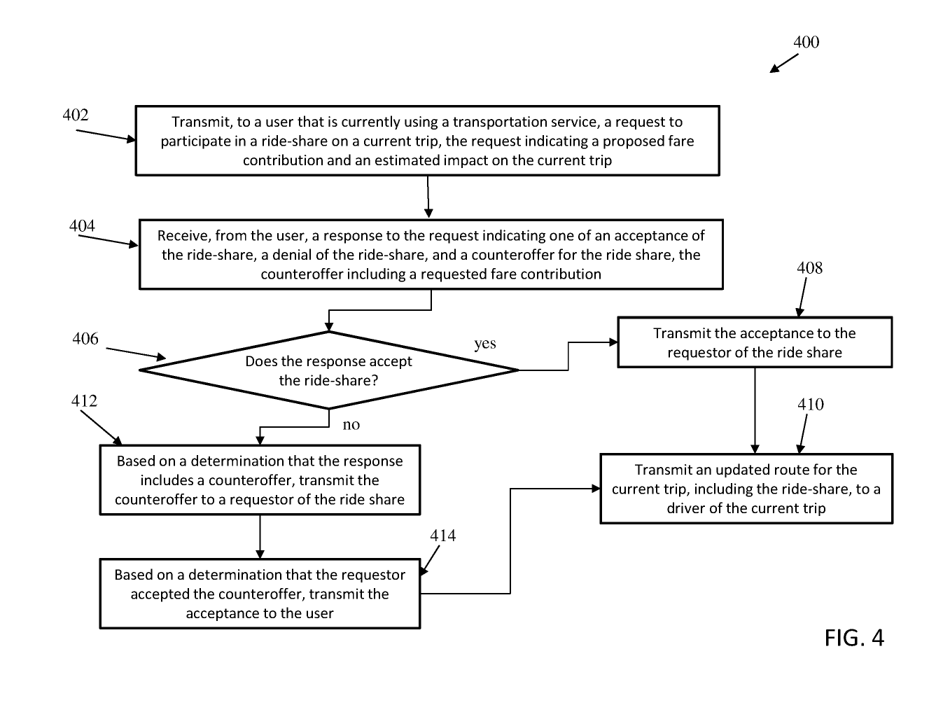

Referring to FIG. 4, a flowchart of a method 400 for determining a fare split for a ride share in accordance with one or more embodiments of the present invention. As illustrated, at block 402, the method 400 includes transmitting, to a user that is currently using a transportation service, a request to participate in a ride share on a current trip. The request includes a proposed fare contribution for the ride share and an estimated impact on the current trip. In exemplary embodiments, the ride sharing system can provide the user with a range of typically proposed fare contributions and can calculate the estimated impact on the current trip.

Next, as shown at block 404, the method 400 includes receiving, from the user, a response to the request indicating one of an acceptance of the ride share, a denial of the ride share, and a counteroffer for the ride share. In exemplary embodiments, the counteroffer includes a requested fare contribution that the user would accept for the proposed ride share. At decision block 406, the method 400 includes determining if the response accepts the requested ride share. If the response accepted the requested ride share, the method 400 proceeds to block 408 and transmits the acceptance to the requestor of the ride share. Next, the method 400 includes transmitting an updated itinerary for the current trip, including the ride share, to a driver of the current trip, as shown at block 410. If the response does not indicate an acceptance of the requested ride share but includes a counteroffer, the method 400 proceeds to block 412 and transmits the counteroffer to a requestor of the ride share based on a determination that the response includes a counteroffer. If the response does not indicate an acceptance of the requested and does not include a counteroffer, the method concludes without establishing a ride share and the requester may begin the process again with a higher proposed fare contribution. Based on a determination that the requestor accepted the counteroffer, the method 400 includes transmitting the acceptance to the user, as shown at block 414. In the event that the requestor denies the counteroffer, the method may conclude without establishing a ride share and the requester may begin the process again with a higher proposed fare contribution.

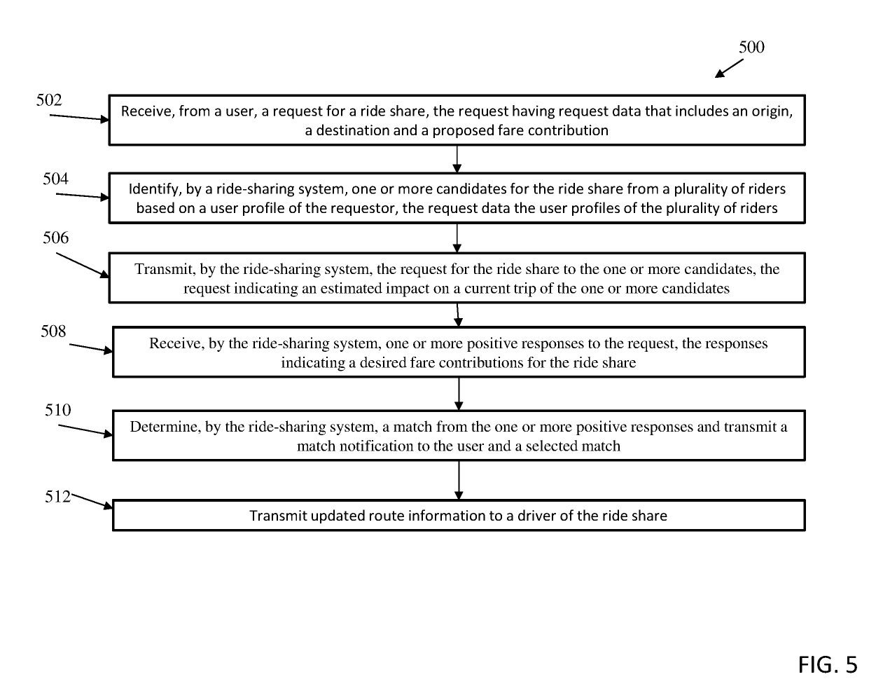

Referring to FIG. 5, a flowchart of a method 500 for determining a fare split for a ride share in accordance with one or more embodiments of the present invention. As illustrated, at block 502, the method 500 includes receiving, from a user, a request for a ride share, the request having request data that includes an origin, a destination, and a proposed fare contribution. Next, as shown at block 504, the method 500 includes identifying, by a ride sharing system, one or more candidates for the ride share from a plurality of riders based on a user profile of the requestor, the request data the user profiles of the plurality of riders. The method 500 also includes transmitting, by the ride sharing system, the request for the ride share to the one or more candidates, the request indicating an estimated impact on a current trip of the one or more candidates, as shown at block 506.

The method 500 also includes receiving, by the ride sharing system, one or more positive responses to the request, the responses indicating a desired fare contribution for the ride share, as shown at block 508. Next, the method 500 includes determining, by the ride sharing system, a match from the one or more positive responses and transmit a match notification to the user and a selected match.

In one embodiment, determining a match includes determining that the proposed fare contribution from the user is greater than or equal to the desired fare contribution from the current rider. In the event that the proposed fare contribution from the user is greater than desired fare contribution from the current rider, the ride sharing system may be configured to split the overage between the riders and optionally the driver according to the ride sharing preferences of the riders. In one embodiment, the ride sharing system, is configured to notify the user that no match exists based on a determination that the proposed fare contribution is less than a lowest of the desired fare contributions. The notification that no match exists can include a minimum proposed fare contribution needed to participate in a ride share. Optionally, when no match is determined the ride sharing system can initiate a bidding process between the user and one or more riders that provided positive responses. The bidding process can be used by the user and the one or more riders that provide positive responses to come to an agreement on a split of the difference between the proposed fare contribution and the desired fare contribution provided.

In one embodiment, determining a match includes determining a new total fare for the ride share and determining that the new total fare is greater than or equal to a previously agreed to fare of the current rider added to the proposed fare contribution from the user. In the event that the sum of the previously agreed fare and the proposed fare contribution exceeds the new total fare, the ride sharing system is configured to split the overage between the riders and optionally the driver according to the ride sharing preferences of the riders. The method 500 also includes transmitting updated itinerary information to a driver of the ride share, as shown at block 510.

In exemplary embodiments, the ride sharing preferences of a user can include the amount of time a user is willing to wait for a ride share in order to reduce the cost of their ride by a given percentage. For example, a user may be willing to wait an additional thirty minutes for the ride share that reduce the cost of their trip by at least twenty-five percent, assuming that the people they share the ride with are compatible to their other preferences.

In exemplary embodiments, the ride-sharing preferences of a user can include specific types of cars that the user prefers to ride in, i.e., SUV, Sedan, hybrid, electric, or the like. For example, a user requesting a ride share may set up their preferences such that they will select electric or hybrid cars that are a match for their request even if they have to wait longer for the ride share or pay more for the ride share.

In exemplary embodiments, the ride-sharing preferences of a user can include specific types of environments or types or roads that the user prefers to travel on or thorough and specific types of environments or types or roads that the user prefers not to travel on or through. For example, a user may prefer to travel on limited access roads or through neighborhood streets. Likewise, another user may prefer to not travel through industrial areas or areas that have a high crime rate.

In exemplary embodiments, if the ride sharing system is not able to find a match for a requested ride share, the ride sharing system can be used to facilitate communication between parties that would have been able to match but for an agreement in price. This communication can be used by the riders to directly negotiate an acceptable price for each rider.

In exemplary embodiments, the determination of a match from the candidates for a ride share can be further based on an analysis of the ratings of the passengers. In this example, passengers could have ratings based on several factors as riders that could affect the sharing price. For example, a rider that has a rating of five stars may be willing to share a ride with a three star rider if the three star rider is willing to pay a larger share of the fare. The three star rider may be willing to ride with a five star rider because they want to increase their rating and also because it is the only option in the area. Even though the three star rider may pay more than the five star rider, they are ok with that because their fare will still be lower than if not sharing the ride. Additionally, both users can use the system to create a bidding process until they reach an agreement on the riding fare.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically identified device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, micro-identifier, firmware instructions, state-setting data, or either source identifier or object identifier written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), a wireless LAN (WLAN using WiFi), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for determining a fare split for a ride share, the method comprising:
receiving, from a user, a request for the ride share, the request comprising request data that includes a pickup location, a drop off location and a proposed fare contribution;
identifying, by a processor of a ride sharing system, one or more candidates for the ride share from a plurality of riders based on a user profile of the user, the request data and a user profile of one or more of the plurality of riders;
transmitting, by the ride sharing system, the request for the ride share to the one or more candidates, the request indicating an estimated impact on a current trip of the one or more candidates;
receiving, by the ride sharing system, one or more positive responses to the request, the responses indicating desired fare contributions for the ride share;
determining, by the processor, a match from the one or more positive responses; and
transmitting, by the ride sharing system, a match notification to the user and a selected match and transmitting an updated itinerary to a driver of the ride share.

2. The computer-implemented method of claim 1, wherein the user profile of the user includes a gender of the user, an age of the user, and a user rating for the user.

3. The computer-implemented method of claim 2, wherein the user rating is generated based on feedback from drivers and other riders in a ride sharing system.

4. The computer-implemented method of claim 1, wherein identifying the one or more candidates for the ride share from the plurality of riders is further based on ride sharing preferences of each of the plurality of riders.

5. The computer-implemented method of claim 4, wherein the ride sharing preferences include a minimum rating of riders that a user is willing to share a ride with, a maximum amount of time a user is willing to wait to obtain a ride share, a preferred gender of riders that a user is willing to share a ride with, and a maximum disruption to a ride that the user is willing to endure to share a ride.

6. The computer-implemented method of claim 1, wherein determining the match from the one or more positive responses includes determining whether the proposed fare contribution is greater than or equal to the desired fare contribution.

7. The computer-implemented method of claim 6, further comprising determining how to divide a difference of the desired fare contribution of a matched rider and the proposed fare contribution amongst the driver, the user and the matched rider based on the updated itinerary and the ride sharing preferences of the user and the matched rider.

8. The computer-implemented method of claim 1, further comprising notifying the user that no match exists based on a determination that the proposed fare contribution is less than a lowest of the desired fare contributions, wherein the notification that no match exists includes a minimum proposed fare contribution needed to participate in a ride share.

9. The computer-implemented method of claim 1, further comprising initiating a bidding process between the user and one or more riders that provided positive responses based on a determination that the proposed fare contribution is less than a lowest of the desired fare contribution.

10. A system for determining a fare split for a ride share, the system comprising:
at least one processor and a memory, operably coupled to the at least one processor, the memory storing processor computer readable instructions;
the at least one processor, configured to execute computer readable instructions, which cause the processor to:
receive, from a user, a request for the ride share, the request comprising request data that includes a pickup location, a drop off location and a proposed fare contribution;
identify one or more candidates for the ride share from a plurality of riders based on a user profile of the user, the request data and a user profile of one or more of the plurality of riders;
transmit the request for the ride share to the one or more candidates, the request indicating an estimated impact on a current trip of the one or more candidates;
receive one or more positive responses to the request, the responses indicating desired fare contributions for the ride share;
determine a match from the one or more positive responses; and
transmit a match notification to the user and a selected match and transmitting an updated itinerary to a driver of the ride share.

11. The system of claim 10, wherein the user profile of the user includes a gender of the user, an age of the user, and a user rating for the user.

12. The system of claim 11, wherein the user rating is generated based on feedback from drivers and other riders in a ride sharing system.

13. The system of claim 10, wherein the user profile of the candidates can be dynamically adjusted by an owner of the user profile in response to the request for the ride share.

14. The system of claim 10, wherein identifying the one or more candidates for the ride share from the plurality of riders is further based on ride sharing preferences of each of the plurality of riders.

15. The system of claim 14, wherein the ride sharing preferences include a minimum rating of riders that a user is willing to share a ride with, a maximum amount of time a user is willing to wait to obtain a ride share, a preferred gender of riders that a user is willing to share a ride with, and a maximum disruption to a ride that the user is willing to endure to share a ride.

16. The system of claim 10, wherein determining the match from the one or more positive responses includes determining whether the proposed fare contribution is greater than or equal to the desired fare contributions.

17. The system of claim 16, wherein the computer readable instructions, further cause the processor to determine how to divide a difference of the desired fare contribution of a matched rider and the proposed fare contribution amongst the driver, the user and the matched rider based on the updated itinerary and the ride sharing preferences of the user and the matched rider.

18. The system of claim 10, wherein the computer readable instructions, further cause the processor to notify the user that no match exists based on a determination that the proposed fare contribution is less than a lowest of the desired fare contributions, wherein the notification that no match exists includes a minimum proposed fare contribution needed to participate in a ride share.

19. A computer program product, the computer program product comprising a computer readable storage medium having program instructions embodied therewith, the program instructions executable by a processor to cause the processor to:
receive, from a user, a request for a ride share, the request comprising request data that includes a pickup location, a drop off location and a proposed fare contribution;
identify one or more candidates for the ride share from a plurality of riders based on a user profile of the user, the request data and a user profile of one or more of the plurality of riders;
transmit the request for the ride share to the one or more candidates, the request indicating an estimated impact on a current trip of the one or more candidates;
receive one or more positive responses to the request, the responses indicating desired fare contributions for the ride share;
determine a match from the one or more positive responses; and
transmit a match notification to the user and a selected match and transmitting an updated itinerary to a driver of the ride share.

20. The computer program product of claim 19, wherein identifying the one or more candidates for the ride share from the plurality of riders is further based on ride sharing preferences of each of the plurality of riders, wherein the ride sharing preferences include a minimum rating of riders that a user is willing to share a ride with, a maximum amount of time a user is willing to wait to obtain a ride share, a preferred gender of riders that a user is willing to share a ride with, and a maximum disruption to a ride that the user is willing to endure to share a ride.
